(19) United States
(12) Patent Application Publication
(10) Pub. No.: US 2017/0251401 A1
(43) Pub. Date: Aug. 31, 2017

(54) TRAFFIC STEERING BETWEEN CELLULAR NETWORKS AND WIRELESS LOCAL AREA NETWORKS (WLANS) USING USER EQUIPMENT (UE) THROUGHPUT ESTIMATES

(71) Applicant: Kyocera Corporation, Kyoto (JP)

(72) Inventor: David COMSTOCK, San Diego, CA (US)

(21) Appl. No.: 15/512,973

(22) PCT Filed: Sep. 25, 2015
(86) PCT No.: PCT/US2015/052419

§ 371 Date: Mar. 21, 2017

Related U.S. Application Data
(60) Provisional application No. 62/056,444, filed on Sep. 26, 2014.

(51) Int. Cl. H04W 28/08; H04W 76/04; H04W 88/06; H04W 36/34; H04W 24/10; H04W 36/22; H04W 24/02; H04W 88/08

(52) U.S. Cl. CPC H04W 28/08; H04W 24/02; H04W 76/041; H04W 88/08; H04W 36/34; H04W 24/10; H04W 36/22; H04W 88/06

(57) ABSTRACT

A user equipment (UE) device determines to switch core network access from a cellular radio access network (RAN) to a wireless local area network (WLAN) RAN for data traffic associated with a packet data network (PDN) at least partially based on a comparison between QoS information of the PDN received from the core network and UE data throughout estimate

### CLAIM OF PRIORITY

The present application claims priority to Provisional Application No. 62/056,444 entitled “Method Of Utilizing UE's Self-Estimated Throughput For Traffic Steering Between 3GPP RAN and WLAN”, docket number TPRO 00260 US, filed Sep. 26, 2014, assigned to the assignee hereof and hereby expressly incorporated by reference in its entirety.

### FIELD

This invention generally relates to wireless communications and more particularly to traffic steering between cellular networks and wireless local area networks (WLANs) that is facilitated by WLAN user equipment (UE) data throughput estimates.

### BACKGROUND

Wireless communication systems use radio access networks (RAN) having communication stations (base stations, eNodeBs, eNBs, access points, APs) to provide geographical service areas where wireless communication user equipment devices (UE devices) communicate with the communication station providing the particular geographical service area in which the UE devices are located. In some situations, multiple RANs provide geographical service areas that at least partially overlap. Where a UE device has the capability to communicate within either RAN, it is sometimes advantageous to offload data traffic from one RAN to another RAN. For example, offloading traffic from a cellular RAN to a wireless local area network (WLAN) RAN can be performed to avoid congestion and maintain a desired level of service on the cellular RAN.

### SUMMARY

A user equipment (UE) device determines to switch radio core network access from a cellular radio access network (RAN) to a wireless local area network (WLAN) RAN for data traffic associated with a packet data network (PDN) at least partially based on a comparison between QoS information of the PDN received from the core network and UE data throughout estimate of WLAN RAN.

### BRIEF DESCRIPTION OF THE DRAWINGS

FIG. 1 is a block diagram of a communication system that supports multiple Radio Access Technologies (RATs) for an example where a user equipment (UE) device determines an estimated throughput value of a wireless local area network (WLAN) connection and determines to switch from a cellular connection to the WLAN connection at least partially based on a comparison between the estimated throughput value and a quality of service (QoS) parameter associated with a data traffic connection provided by a core network.

FIG. 2 is a block diagram of the communication system for the example where the packet core is an evolved packet core (EPC), the cellular RAN operates in accordance with at least one revision of the 3GPP LTE specification, and the WLAN RAN is part of a WLAN operating in accordance with an Institute of Electrical and Electronics Engineers (IEEE) 802.11 communication standard.

FIG. 3 is a block diagram of an example of a UE device suitable for use as the UE device in FIG. 1 and FIG. 2.

FIG. 4 is a flow chart of a method of switching from a cellular RAN to a WLAN RAN.

### DETAILED DESCRIPTION

As discussed above, offloading traffic from a cellular RAN to a wireless local area network (WLAN) RAN can be performed to avoid congestion and maintain a desired level of service on the cellular RAN. Many criteria may be used to determine when to steer data traffic between a cellular RAN and a WLAN RAN, including, for example, the current data traffic load of both RANs. The 3GPP LTE RAN specifications provide features to facilitate data traffic offload between an eNB and a WLAN RAN. For example, an eNB may provide UE devices with threshold values for several parameters associated with the current load of both the eNB and the WLAN RAN. A UE device may steer data traffic between an eNB and a WLAN RAN based on comparisons of these thresholds with the current values of the associated RAN parameters that it has obtained through measurement or through other means. However, these threshold values provided by the eNB do not provide sufficient information for the UE device to determine whether the WLAN RAN would be able to provide an acceptable level of service if certain data traffic were to be offloaded. What is needed are methods that facilitate the prediction of whether a WLAN RAN is able to provide an acceptable level of service if certain data traffic were to be offloaded.

As discussed herein, a UE device makes data traffic steering decisions at least partially based on comparison of the QoS parameter for data traffic for a Packet Data Network (PDN) and an estimated throughput for a WLAN RAN. The user equipment (UE) device is connected to one or more PDNs through a core network that provides the point of entry/exit for data traffic associated with each PDN. The core network performs the necessary services to manage network access, such as traffic management and provides the UE device with QoS information associated with each PDN's data traffic. For each PDN connection, the UE selects either a cellular RAN or a WLAN RAN to access the core network in order to exchange data traffic associated with the particular PDN. The UE device selects between the WLAN RAN and the cellular RAN at least partially based on a comparison between the PDN's QoS information, such as maximum bit rate, received from the core network, and the UE data throughput estimate. The WLAN UE data throughput estimates may be based on information obtained from measurements and control signaling. The WLAN RAN may be considered for selection if its associated data throughput estimate is greater than the maximum data bit rate for the specific PDN data traffic, for example.

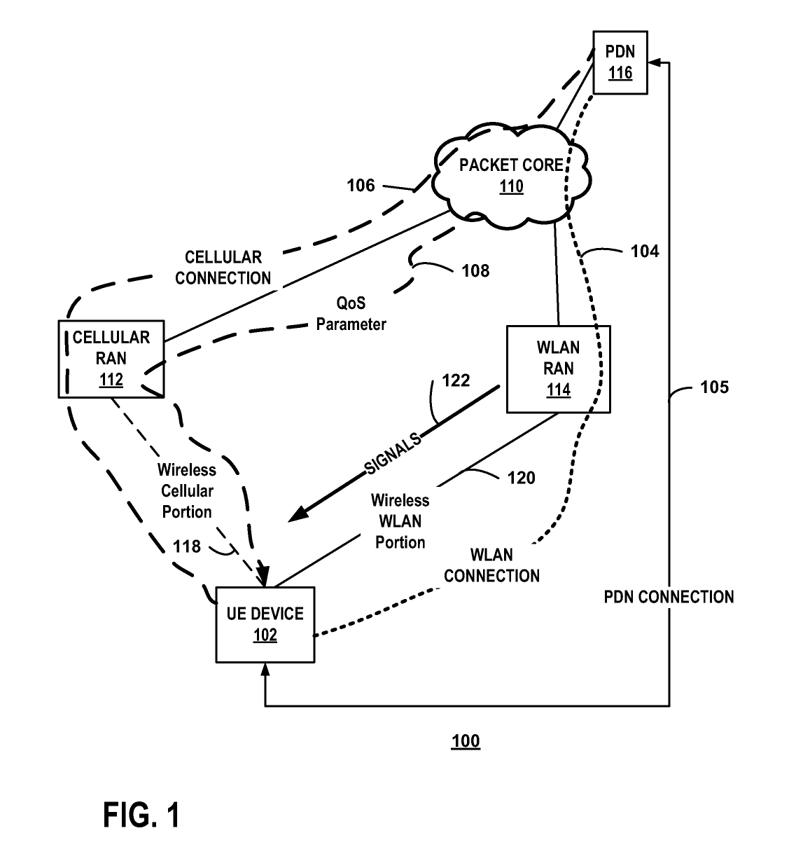

FIG. 1 is a block diagram of a communication system 100 that supports multiple Radio Access Technologies (RATs) for an example where a user equipment (UE) device 102 determines an estimated throughput value of a wireless local area network (WLAN) connection 104 and determines to switch data traffic for a PDN connection 105 from a cellular connection 106 to the WLAN connection 104 at least partially based on a comparison between the estimated throughput value and a quality of service (QoS) parameter 108 associated with the data traffic connection 105 provided by a core network 110.

The packet core 110 in the system 100 includes equipment and backhaul that connects radio access networks (RANs) such as a cellular RAN 112 and the a WLAN RAN 114 to one or more packet data networks (PDNs) 116 such as the Internet or other IP services. The packet core identifies each PDN with an Access Point Name (APN). The packet core 110 can be any combination of entities that route data and control signals to establish and manage communication between the RANs and PDNs 116. In one example, as discussed below in further detail, the packet core 110 is an Evolved Packet Core (EPC) that applies a System Architecture Evolution (SAE) core network architecture used in revisions of The Third-Generation Partnership Project Long-Term Evolution (3GPP LTE) communication specification. As discussed herein, a RAN includes the equipment that implements a Radio Access Technology (RAT) that is accessible by UE devices via wireless communication over an air interface. A Radio Access Technology (RAT) is the underlying physical connection method for a radio based communication network. A RAN includes a base station, eNB, access point or other similar device for wirelessly communicating with UE devices. For the examples herein, the cellular RAN 112 implements a cellular RAT such as one that operates in accordance with one or more revisions of the 3GPP specification and the WLAN RAN 114 implements a WLAN RAT such as a WiFi RAT operating in accordance with an IEEE 802.11 standard.

For the example of FIG. 1, the UE device 102 is communicating with the packet data network 116 through the cellular connection 106 which includes a wireless cellular portion 118. The cellular radio access network (RAN) is connected to the packet core 110 and provides wireless service to the UE device 102 to form the wireless cellular portion 118 of the cellular connection 106. An example of a suitable cellular RAT includes a RAT operating in accordance with one or more revisions of The Third-Generation Partnership Project Long-Term Evolution (3GPP LTE) communication specification. The UE device 102 also has the capabilities to communicate with the WLAN RAN 114 over a wireless interface. The WLAN RAN 114 provides wireless services to the UE device 102 to form a wireless WLAN portion 120 of the WLAN connection 104 when the UE device 102 is communicating with the PDN 116 over the WLAN connection 104.

While the UE device 102 is connected to the PDN 116 through the cellular connection 106, the UE device 102 determines an estimated throughput value of a WLAN connection 104 for data traffic of a particular PDN. Any suitable method for determining the estimated throughput may be used where the technique may depend on the particular implementation. An illustrative method for determining an estimated throughput has been approved for inclusion in a revision of the IEEE 802.11 specification (draft IEEE Std P802.11-REVmc), which is currently in a balloting stage of development. The method currently described in this draft specification determines an estimated throughput based on measurements and on parameters obtained from network nodes, including parameters included in signals 122 received from the WLAN RAN 114, where data traffic potentially may be offloaded. Often, the WLAN RAN provides an estimate for these parameters since there may not be an active association between the WLAN RAN and the UE device. Some of the parameters that may be used for the estimated throughput includes: a signal strength measurement (RSSI), an estimate of the average number of octets per data unit expected to be delivered to the UE device, the number of spatial streams that is expected to be supported on the link between the WLAN RAN and the UE device, the channel bandwidth, the predicted percentage of time that the UE would be allocated air time (Air Fractional Time), the Block Acknowledgement Window size, the expected transmission duration that would be allocated for data transmissions.

The UE device 102 also receives the QoS parameter 108 from the packet core that is based on the traffic management functions performed on the data traffic for the PDN 116. As discussed below, the QoS parameter 108 can be a maximum data bit rate for a connection between a particular PDN and a particular UE device. The UE device 102 determines that the WLAN connection 104 is suitable for providing service to the PDN if the estimated throughput value can support at least the data rate indicated by the QoS parameter 108. The UE device determines to steer traffic for the PDN to the WLAN connection 104 at least partially based on determination of whether the WLAN can support the QoS indicated by the QoS parameter.

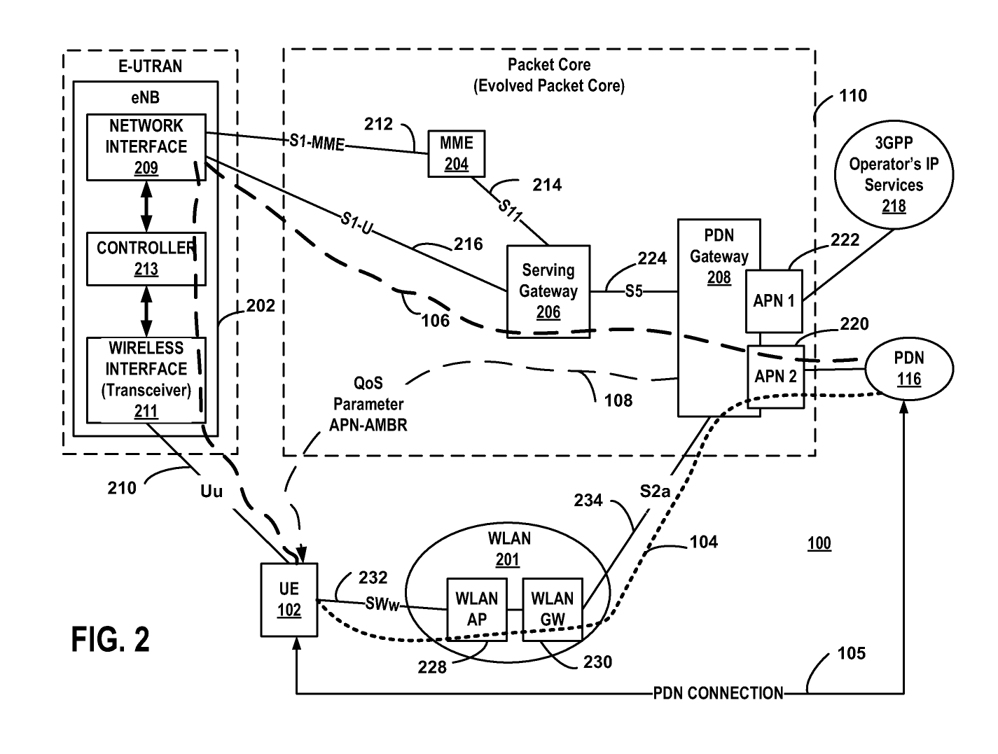

FIG. 2 is a block diagram of the communication system 100 for the example where the packet core 110 is an evolved packet core (EPC), the cellular RAN 112 operates in accordance with at least one revision of the 3GPP LTE specification, and the WLAN RAN 102 is part of a WLAN 201 operating in accordance with an IEEE 802.11 communication standard. For the example, the EPC 110 includes an eNB 202, a Mobility Management Entity (MME) 204, serving Gateway 206, Packet Data Network (PDN) Gateway 208, as well as other equipment and entities. In the interest of brevity and clarity, some of the functional blocks and components have been omitted from FIG. 2. For example, the Policy Control and Charging Rules Function (PCRF), the 3GPP Authentication, Authorization and Accounting (AAA) server and the Home Subscriber Server (HSS) are not shown in the figure.

The Evolved Node B 202 is a fixed transceiver station, sometimes referred to as a base station, an eNodeB or eNB, which may include some controller functions in some circumstances. The eNB 202 is connected to the network through a backhaul which may include any combination of wired, optical, and/or wireless communication channels. A network interface 209 in the eNB 202 facilitates communication through the backhaul using the appropriate communication interface and protocol.

The eNB 202 includes a wireless interface (transceiver) 211 for communicating with the UE devices over the Uu interface 210 that uses the LTE air interface and supports Radio Resource Control (RRC) control signaling. The LTE air interface uses orthogonal frequency-division multiplexing (OFDM) on the downlink and single-carrier frequency-division multiple access (SC-FDMA) on the uplink. The transceiver 211 exchanges wireless signals with the UE device 102. Transmissions from the eNB and from the UE devices are governed by a communication specification that defines signaling, protocols, and parameters of the transmission. The communication specification may provide strict rules for communication and may also provide general requirements where specific implementations may vary while still adhering to the communication specification. Although the discussion herein is directed to the 3GPP Long Term Evolution (LTE) communication specification, other communication specifications may be used in some circumstances. The communication specification defines at least a data channel and a control channel for uplink and downlink transmissions and specifies at least some timing and frequency parameters for physical channels. The transceiver 211, therefore, includes at least a downlink transmitter for transmitting downlink signals and an uplink receiver for receiving uplink signals. The eNB also includes a controller 213 that performs, in conjunction with the other eNB components, the functions described herein as well as facilitating the overall functionality of the eNB 202. The eNB 202, therefore, includes a transceiver 211, a controller 213, and a network interface 209 as well as other components and circuitry (not shown) such as memory, for example.

The Mobility Management Entity (MME) 204 is a control-node for the LTE access-network. The MME 204 performs functions such as idle mode UE (User Equipment) paging and tagging procedures including retransmissions. The MME facilitates bearer activation and deactivation process and also selects the serving gateway that will be used by a UE device. The MME 204 communicates with the eNB 202 over a S1-MME interface 212 using S1 Application Protocol (S1-AP) control data. Control data is exchanged between the MME and the serving gateway using GPRS Tunneling Protocol over an S11 interface 214.

The serving gateway 206 routes and forwards user data packets and facilitates inter-eNodeB handovers as well as mobility between LTE and other 3GPP technologies. The serving gateway 206 also manages and stores UE contexts such as parameters of the IP bearer service and network internal routing information. The serving gateway 206 communicates with the eNB 202 using GPRS Tunneling Protocol over the S1-U interface 216.

The PDN Gateway 208 provides connectivity between the UE device 106 and external packet data networks (PDNs) 116, 218 by being the point of exit and entry of traffic for the UE device 102. A UE device 102 may have simultaneous connectivity with more than one PDN gateway for accessing multiple PDNs. The PDN gateway 208 manages PDN data traffic access to the core network and performs policy enforcement, packet filtering for each user, charging support, lawful interception and packet screening. The PDN gateway also facilitates mobility between 3GPP and non-3GPP technologies such as WLAN technologies. For the example, the PDN Gateway provides connectivity to two PDNs 116, 218 including a first PDN 116 and a second PDN 218. The second PDN 218 may include the 3GPP operator's IP services for example. Each PDN 116, 218 is identified with a unique Access Point Name (APN) 220, 222. Control data and user data is transported between the PDN gateway and the serving gateway using GPRS Tunneling Protocol over an S5 interface 224.

The wireless user equipment communication device (UE device) 102 may be referred to as a mobile device, wireless device, wireless communication device, mobile wireless device, UE, UE device as well as by other terms. The UE device 106 includes electronics and code for communicating with eNBs, base stations, wireless access points and, sometimes, with other UE devices in device-to-device (D2D) configurations. The UE devices include devices such as cell phones, personal digital assistants (PDAs), wireless modem cards, wireless modems, televisions with wireless communication electronics, and laptop and desktop computers as well as other devices. The combination of wireless communication electronics with an electronic device, therefore, may form a UE device 106. For example, a UE device 106 may include a wireless modem connected to an appliance, computer, television, or other device.

The WLAN 201 includes a WLAN access point (AP) 228 and a WLAN gateway 230. The UE device 106 accesses WLAN AP 228 of the WLAN 226 through an SWw interface 232 such as an air interface operating in accordance with an IEEE 802.11 standard. The UE device 102, therefore, includes electronics and code to facilitate communication through the SWw interface 232 using IEEE 802.11 protocols.

The WLAN gateway 230 of the WLAN 201 communicates with the PDN gateway 208 over an S2a interface 234. The WLAN gateway 230 uses GPRS tunneling for communication with the PDN gateway 208 and establishes a GTPv2, PMIP or MIP tunnel to the PDN gateway 208 in the EPC 110 for all trusted traffic.

For the example herein, the UE device is connected to a first PDN 116 through cellular connection 106, which is provided by the cellular air interface 210 to the eNB, the serving gateway 206 and the PDN gateway 208. Over signaling that is transparent to the eNB, the PDN gateway sends the UE device the QoS parameter 108. For the example of FIG. 2 the QoS parameter includes at least the APN Aggregated Maximum Bit Rate (APN-AMBR) associated with the UE device's PDN connection 105 to the PDN 116. The UE device determines the estimated throughput value for a connection through the WLAN for the PDN data traffic. The UE device determines an estimated throughput value for the PDN connection if the associated data traffic were to be switched from the cellular RAN to the WLAN RAN. The UE estimated throughput may be based on at least the signals received from WLAN AP. The UE device evaluates the estimated throughput value and compares it to the QoS parameter to determine whether the WLAN connection could support the QoS requirements of the connection to the PDN 116. For the example, the UE device determines traffic steering at least partially based on whether the estimated throughput value is greater than or equal to the APN-AMBR.

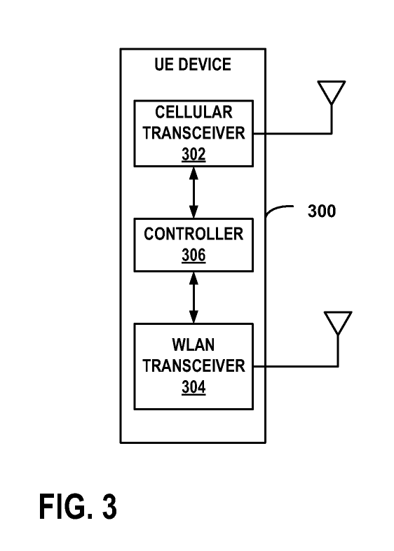

FIG. 3 is a block diagram of an example of a UE device 300 suitable for use as the UE device 102 in FIG. 1 and FIG. 2. The UE device 300 includes a cellular transceiver 302, a WLAN transceiver 304 and a controller 306, as well as other components and circuitry (not shown) such as memory and a user interface, for example. Any description with reference to FIG. 3 of the various functions and operations of such equipment may be implemented in any number of devices, circuits, or elements. Two or more functional blocks may be integrated in a single device, and the functions described as performed in any single device may be implemented over several devices in some circumstances. For example, at least portions of the cellular transceiver 302 may perform functions of the WLAN transceiver 304.

The cellular transceiver 302 includes a transmitter that transmits cellular uplink wireless signals to eNBs and a receiver that receives cellular downlink wireless signals from eNBs over the uplink and downlink channels of the Uu air interface, respectively. For the example, the cellular transceiver 302 operates in accordance with at least one revision of the 3GPP LTE communication specification. The transceiver 302 can also be configured to transmit and receive D2D signals using allocated cellular resources, such as uplink communication resources, for example.

The WLAN transceiver 304 includes a transmitter that transmits WLAN uplink wireless signals to WLAN APs and a receiver that receives WLAN downlink wireless signals from WLAN APs over the uplink and downlink channels of the SWw air interface, respectively. For the example, the WLAN transceiver 304 operates in accordance with the IEEE 802.11 communication standard.

The controller 306 controls components of the UE device 300 to manage the functions of the device 300 described herein as well as to facilitate the overall functionality of the UE device 300. The controller 304 is connected to the transceivers 302, 304 and other components, such as memory.

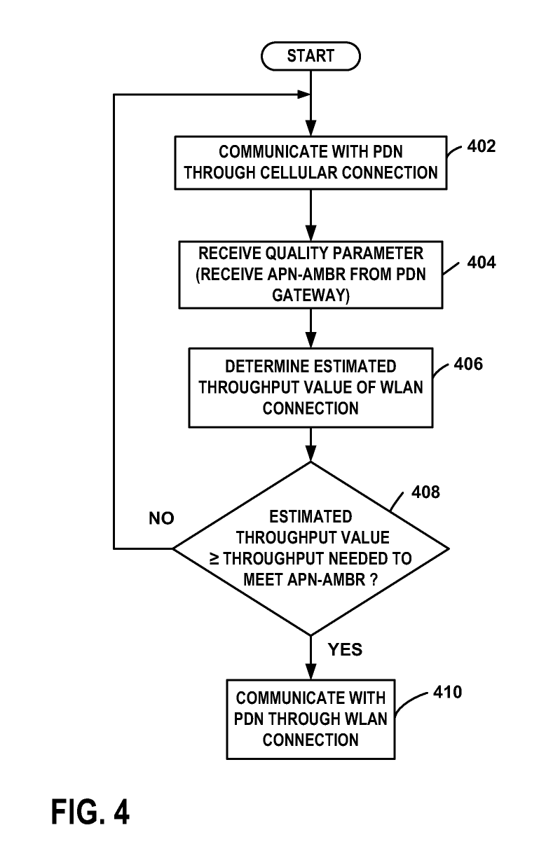

FIG. 4 is a flow chart of a method of switching from a cellular RAN to a WLAN RAN. For the example, the method is performed by a UE device such as 102, 300.

At step 402, the UE device 102 communicates with a PDN 116 through a cellular connection 106. Accordingly, the UE device communicates with the eNB and through the EPC to exchange data with the PDN 116.

At step 404, the UE device 102 receives a quality of service (QoS) parameter indicative of the QoS of the connection to the PDN 116. For the example, the UE device 102 receives an APN-AMBR parameter over signaling that is transparent to the eNB.

At step 406, the UE device 102 determines the estimated throughput value of the WLAN connection 104 for data traffic associated with PDN 116 if the data traffic were to be switched to the WLAN RAN. For the example, the UE device 102 measures signals transmitted by the WLAN AP and obtains parameters to derive the estimated throughput value. An example of a suitable technique is the procedure proposed by the IEEE 802.11 WLAN working group where several parameters are evaluated to generate the estimated throughput value. The estimated throughput value is indicative of the available resource capacity of the WLAN RAN to serve the PDN data traffic for the UE device. As discussed above, an example of suitable technique for determining the estimated throughput value includes the technique that has been approved for inclusion in a revision of the IEEE 802.11 specification (draft IEEE Std P802.11-REVmc),

At step 408, the UE device 102 determines whether the WLAN connection 104 could support the QoS of the PDN 116 data traffic. For the example, the UE determines whether the estimated throughput value is greater than or equal to the throughput required for the APN-AMBR. If the estimated throughput value is insufficient, the procedure returns to step 402 where the UE device continues to use the cellular connection to access the PDN 116. Otherwise, the procedure continues at step 410 where the UE device switches to the WLAN connection 104 to continue communicating with the PDN 116. For the example, the UE device executes the transition to steer traffic to the WLAN in accordance with known techniques.

The devices and techniques discussed above have several advantages over other techniques for steering traffic to the WLAN based on a WLAN estimated throughput value. For example, the cellular RAN could use broadcast control signaling to provide UE devices with a throughput threshold value to compare with the estimated throughput value when determining when to change connections (i.e., steer traffic to an alternate RAN). This technique is used in the LTE specifications to broadcast other parameter thresholds that may be used to help UE devices to select between a cellular RAN and a WLAN RAN for PDN data traffic. Adding an additional parameter threshold would require more of the radio bandwidth. Also, commonly, traffic steering between a cellular RAN and a WLAN RAN can only be done for data at the APN level of granularity. When performed at the APN level, traffic from the same APN must be steered through the same RAN. For example, traffic from one APN could be steered through the 3GPP RAN and traffic from a different APN could be steered through the WLAN.

In systems operating in accordance with 3GPP LTE, the RAN is not aware of APN-level granularity of data traffic. The RAN only has information at the radio bearer granularity. Bearers are made up multiple IP Flows that have similar QoS requirements but do not include all of the IP Flows from an APN. For this reason, the 3GPP RAN would not have knowledge about appropriate throughput thresholds for all the data for an APN. The RAN only has QoS information that applies to radio bearers. It would be inconsistent with the system architecture of LTE/EPC for the RAN to have this APN-specific information. Since the UE's estimated throughput is for the data associated with an APN, the 3GPP RAN should not provide thresholds for the throughput parameter.

On the other hand, the techniques discussed herein take advantage of the fact that a UE device has information at the APN granularity. The UE device has the APN Aggregated Maximum Bit Rate (APN-AMBR) QoS parameter that it receives from the core network. The APN-AMBR is the maximum bit rate for non-guaranteed bit rate data that is allowed from an APN for a UE device and is controlled by the PDN gateways associated with an APN. As discussed herein, the UE device can compare the estimated throughput with the current APN-AMBR to determine whether the WLAN can support the level of traffic that will be coming from a particular APN for non-guaranteed bit rate data. The UE device can apply other QoS parameters to guaranteed bit rate data to determine whether or not it should steer traffic for an APN to the WLAN.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A method comprising:
exchanging data between a user equipment (UE) device and a packet data network over a first connection between the UE device and the packet data network, the first connection including a cellular wireless portion through a cellular radio access network (RAN);
receiving a quality of service (QoS) parameter indicative of a QoS level for the first connection;
determining, at the UE device, an estimated throughput value indicative of data throughput through a second connection between the UE device and the packet data network, the second connection including a wireless local area network (WLAN) wireless portion through a WLAN RAN; and
determining, based at least on the QoS parameter and the estimated throughput value, whether to switch from the first connection to the second connection.

2. The method of claim 1, wherein the cellular RAN operates in accordance with at least one version of The Third-Generation Partnership Project Long-Term Evolution (3GPP LTE) communication specification.

3. The method of claim 2, wherein an access point name (APN) is associated with the packet data network and the receiving the QoS parameter comprises receiving an APN Aggregated Maximum Bit Rate (APN-AMBR) QoS parameter from a packet data network gateway in an Evolved Packet Core (EPC).

4. The method of claim 3 wherein the determining whether to switch from the first connection to the second connection comprises determining whether the estimated throughput value is greater than or equal to the APN-AMBR.

5. The method of 3, wherein the UE device is connected to a plurality of packet data networks (PDNs) through a plurality of PDN connections through the EPC, the EPC establishing each PDN connection by providing an entry point and an exit point for data traffic associated with each PDN, the UE device exchanging data with each PDN through the associated PDN connection of a plurality of PDN connections.

6. The method of claim 5, further comprising:
receiving a APN-AMBR parameter from the core network for each PDN connection; and
determining whether to steer data of each PDN connection through the WLAN RAN at least partially based on whether the estimated throughput value is greater than or equal to the APN-AMBR associated with the PDN connection.

7. The method of claim 4, wherein the determining the estimated throughput value comprises determining the estimated throughput value in accordance with a revision of a Institute of Electrical and Electronics Engineers (IEEE) 802.11 specification.

8. The method of claim 7, wherein the APN-AMBR is generated by a PDN gateway within the core network.

9. A user equipment (UE) device comprising:
a first transceiver configured to communicate with a cellular radio access network (RAN) to establish a cellular wireless portion of a first connection to a packet data network (PDN);
the first transceiver comprising a receiver configured to receive a signal comprising a quality of service (QoS) parameter indicative of a QoS level for the first connection, the QoS parameter generated within a core network connecting the cellular RAN to the PDN;
a second transceiver configured to communicate with a wireless local area network RAN; and
a controller configured to:
determine an estimated throughput value indicative of data throughput through a second connection between the UE device and the packet data network, the second connection including a wireless local area network (WLAN) wireless portion through the WLAN RAN; and
determine, based at least on the QoS parameter and the estimated throughput value, whether to switch from the first connection to the second connection.

10. The UE device of claim 9, wherein the cellular RAN operates in accordance with at least one version of The Third-Generation Partnership Project Long-Term Evolution (3GPP LTE) communication specification.

11. The UE device of claim 10, wherein an access point name (APN) is associated with the packet data network and the QoS parameter is an APN Aggregated Maximum Bit Rate (APN-AMBR) QoS parameter from a packet data network gateway in an Evolved Packet Core (EPC).

12. The UE device of claim 11, wherein the controller determines whether to switch from the first connection to the second connection by at least determining whether the estimated throughput value is greater than or equal to the APN-AMBR.

13. The UE device of 11, wherein the UE device is connected to a plurality of packet data networks (PDNs) through a plurality of PDN connections through a core network, the core network establishing each PDN connection by providing an entry point and an exit point for data traffic associated with each PDN, the UE device exchanging data with each PDN through the associated PDN connection of a plurality of PDN connections.

14. The UE device of claim 13, wherein:
the receiver is configured to receive an APN-AMBR parameter from the core network for each PDN connection; and
the controller is configured determine whether to steer data of each PDN connection through the WLAN RAN at least partially based on whether the estimated throughput value is greater than or equal to the APN-AMBR associated with the PDN connection.

15. The UE device of claim 9, wherein the controller is configured to determine the estimated throughput value by determining the estimated throughput value in accordance with a revision of a Institute of Electrical and Electronics Engineers (IEEE) 802.11 specification.
